(19) United States
(12) Patent Application Publication
(10) Pub. No.: US 2016/0222794 A1
(43) Pub. Date: Aug. 4, 2016

(54) INCIDENCE TOLERANT ENGINE COMPONENT

(71) Applicant: UNITED TECHNOLOGIES CORPORATION, Hartford, CT (US)

(72) Inventors: Thomas N. Slavens, Vernon, CT (US); Mark F. Zelesky, Bolton, CT (US); Atul Kohli, Tolland, CT (US); Sean D. Bradshaw, Worcester, MA (US); Steven Bruce Gautschi, Naugatuck, CT (US)

(21) Appl. No.: 14/917,879

(22) PCT Filed: Sep. 9, 2014
(86) PCT No.: PCT/US2014/054725

§ 371 Date: Mar. 9, 2016

Related U.S. Application Data
(60) Provisional application No. 61/875,285, filed on Sep. 9, 2013.

(51) Int. Cl. F01D 5/18; F01D 9/04; F01D 25/12; F04D 29/08; F04D 29/32; F04D 29/58; F04D 29/54; F01D 5/14; F01D 11/08

(52) U.S. Cl. CPC F01D 5/187; F01D 5/147; F01D 9/041; F01D 25/12; F01D 11/08; F04D 29/324; F04D 29/325; F04D 29/5846; F04D 29/542; F04D 29/083; F05D 2220/32; F05D 2260/202

(57) ABSTRACT

This disclosure relates to a gas turbine engine including a component having a leading edge, a pressure side and a suction side opposite the pressure side. The component includes a first group of showerhead holes in the leading edge and a second group of showerhead holes in one of the pressure side and the suction side. The component further includes a first core passageway and a second core passageway separate from the first core passageway. The first core passageway and the second core passageway are in communication with a respective one of the first group of showerhead holes and the second group of showerhead holes.

### BACKGROUND

Gas turbine engines typically include a compressor section, a combustor section and a turbine section. During operation, air is pressurized in the compressor section and is mixed with fuel and burned in the combustor section to generate hot combustion gases. The hot combustion gases are communicated through the turbine section, which extracts energy from the hot combustion gases to power the compressor section and other gas turbine engine loads.

Both the compressor and turbine sections may include alternating series of rotating blades and stationary vanes that extend into the core flow path of the gas turbine engine. Engine components, such as turbine blades and vanes, are known to be cooled by routing a cooling fluid radially within a main core body passageway. In some examples, cooling fluid is directed out an exterior surface of the component via a plurality of showerhead holes to create a showerhead film, which protects the component from the relatively hot gases flowing within the core flow path.

### SUMMARY

One exemplary embodiment of this disclosure relates to a gas turbine engine including a component having a leading edge, a pressure side and a suction side. The component includes a first group of holes in the leading edge and a second group of holes in one of the pressure side and the suction side. The component further includes a first core passageway and a second core passageway separate from the first core passageway. The first core passageway and the second core passageway are in communication with a respective one of the first group of holes and the second group of holes.

In a further embodiment of the foregoing, the first and second groups of holes are groups of showerhead holes.

In a further embodiment of any of the foregoing, the component includes a third group of showerhead holes in the other of the pressure side and the suction side. The component further includes a third core passageway separate from the first and second core passageways. The third core passageway is in communication with the third group of showerhead holes.

In a further embodiment of any of the foregoing, the component includes a pressure side wall and a suction side wall, and further includes a first passageway provided in one of the pressure side wall and the suction side wall configured to communicate fluid from the second core passageway to the second group of showerhead holes.

In a further embodiment of any of the foregoing, the first passageway feeds the second group of showerhead holes in series.

In a further embodiment of any of the foregoing, the component includes a second passageway provided in the other of the pressure side wall and the suction side wall configured to communicate fluid from the third core passageway to the third group of showerhead holes.

In a further embodiment of any of the foregoing, the second passageway feeds the third group of showerhead holes in series.

In a further embodiment of any of the foregoing, the component includes an airfoil section, and wherein the first and second core passageways prevent a flow of fluid within the first core passageway from intermixing with a flow of fluid within the second core passageway when flowing within the airfoil section.

In a further embodiment of any of the foregoing, the component is a turbine blade.

Another exemplary embodiment of this disclosure relates to a component for a gas turbine engine including an airfoil section having a leading edge, a pressure side, and a suction side. The component further includes a first group of showerhead holes in the leading edge and a second group of showerhead holes in one of the pressure side and the suction side. The component also includes a first core passageway and a second core passageway configured to communicate fluid within the airfoil section. The second core passageway is separate from the first core passageway. The first core passageway and the second core passageway are in communication with a respective one of the first group of showerhead holes and the second group of showerhead holes.

In a further embodiment of any of the foregoing, the component includes a pressure side wall and a suction side wall, and includes a first passageway provided in one of the pressure side wall and the suction side wall configured to communicate fluid from the second core passageway to the second group of showerhead holes.

In a further embodiment of any of the foregoing, the component includes a third group of showerhead holes in the other of the pressure side and the suction side. The component also includes a third core passageway separate from the first core passageway and the second core passageway. The third group of showerhead holes are in communication with the third core passageway.

In a further embodiment of any of the foregoing, the component includes a second passageway provided in the other of the pressure side wall and the suction side wall configured to communicate fluid from the third core passageway to the third group of showerhead holes.

In a further embodiment of any of the foregoing, the component is a turbine blade.

In a further embodiment of any of the foregoing, a variable vane is upstream of the turbine blade.

Another exemplary embodiment of this disclosure relates to a method of operating a gas turbine engine. The method includes cooling a first location on an exterior of an engine component with a first flow of fluid. The method further includes cooling a second location on an exterior of the engine component with a second flow of fluid separate from the first flow of fluid.

In a further embodiment of any of the foregoing, the method includes creating a showerhead film adjacent a leading edge and at least one of a suction side and a pressure side of the component, and directing a portion of a core airflow toward the component.

In a further embodiment of any of the foregoing, the method includes changing an angle of incidence of the portion of the core airflow relative to the component.

In a further embodiment of any of the foregoing, the method includes creating a showerhead film adjacent both of the pressure side and the suction side of the component.

In a further embodiment of any of the foregoing, the method includes providing the first flow of fluid from a first core passageway of the component to create the showerhead film adjacent the leading edge, and providing the second flow of fluid from a second core passageway of the component to create a showerhead film adjacent one of the pressure side and the suction side.

In a further embodiment of any of the foregoing, the method includes providing a third flow of fluid from a third core passageway of the component to create a showerhead film adjacent the other of the pressure side and the suction side.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

The drawings can be briefly described as follows:

FIG. 1 schematically illustrates a gas turbine engine.

FIG. 2 illustrates a prior art engine component.

FIG. 3 illustrates a component according to this disclosure.

### DETAILED DESCRIPTION

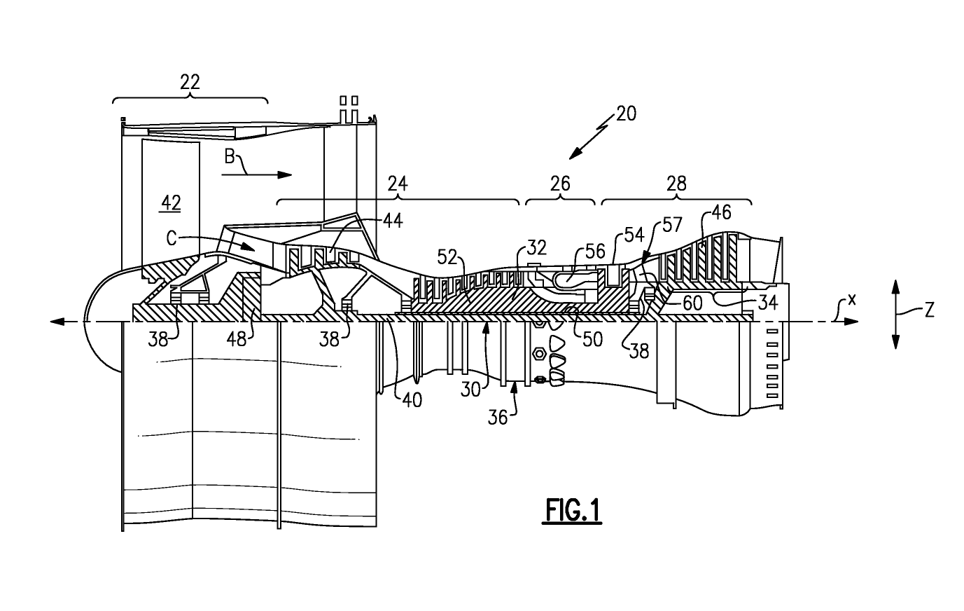

FIG. 1 schematically illustrates an example gas turbine engine 20 that includes a fan section 22, a compressor section 24, a combustor section 26 and a turbine section 28. Alternative engines might include an augmenter section (not shown) among other systems or features. The fan section 22 drives air along a bypass flow path B while the compressor section 24 draws air in along a core flow path C where air is compressed and communicated to a combustor section 26. In the combustor section 26, air is mixed with fuel and ignited to generate a high pressure exhaust gas stream that expands through the turbine section 28 where energy is extracted and utilized to drive the fan section 22 and the compressor section 24.

Although the disclosed non-limiting embodiment depicts a turbofan gas turbine engine, it should be understood that the concepts described herein are not limited to use with turbofans as the teachings may be applied to other types of turbine engines; for example a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section. The concepts disclosed herein can further be applied outside of gas turbine engines.

The example engine 20 generally includes a low speed spool 30 and a high speed spool 32 mounted for rotation about an engine central longitudinal axis X relative to an engine static structure 36 via several bearing systems 38. It should be understood that various bearing systems 38 at various locations may alternatively or additionally be provided.

The low speed spool 30 generally includes an inner shaft 40 that connects a fan 42 and a low pressure (or first) compressor section 44 to a low pressure (or first) turbine section 46. The inner shaft 40 drives the fan 42 through a speed change device, such as a geared architecture 48, to drive the fan 42 at a lower speed than the low speed spool 30. The high-speed spool 32 includes an outer shaft 50 that interconnects a high pressure (or second) compressor section 52 and a high pressure (or second) turbine section 54. The inner shaft 40 and the outer shaft 50 are concentric and rotate via the bearing systems 38 about the engine central longitudinal axis X.

A combustor 56 is arranged between the high pressure compressor 52 and the high pressure turbine 54. In one example, the high pressure turbine 54 includes at least two stages to provide a double stage high pressure turbine 54. In another example, the high pressure turbine 54 includes only a single stage. As used herein, a “high pressure” compressor or turbine experiences a higher pressure than a corresponding “low pressure” compressor or turbine.

The example low pressure turbine 46 has a pressure ratio that is greater than about five (5). The pressure ratio of the example low pressure turbine 46 is measured prior to an inlet of the low pressure turbine 46 as related to the pressure measured at the outlet of the low pressure turbine 46 prior to an exhaust nozzle.

A mid-turbine frame 57 of the engine static structure 36 is arranged generally between the high pressure turbine 54 and the low pressure turbine 46. The mid-turbine frame 57 further supports bearing systems 38 in the turbine section 28 as well as setting airflow entering the low pressure turbine 46.

The core airflow C is compressed by the low pressure compressor 44, then by the high pressure compressor 52, mixed with fuel and ignited in the combustor 56 to produce high speed exhaust gases that are then expanded through the high pressure turbine 54 and low pressure turbine 46. The mid-turbine frame 57 includes vanes 60, which are in the core airflow path and function as an inlet guide vane for the low pressure turbine 46. Utilizing the vane 60 of the mid-turbine frame 57 as the inlet guide vane for low pressure turbine 46 decreases the length of the low pressure turbine 46 without increasing the axial length of the mid-turbine frame 57. Reducing or eliminating the number of vanes in the low pressure turbine 46 shortens the axial length of the turbine section 28. Thus, the compactness of the gas turbine engine 20 is increased and a higher power density may be achieved.

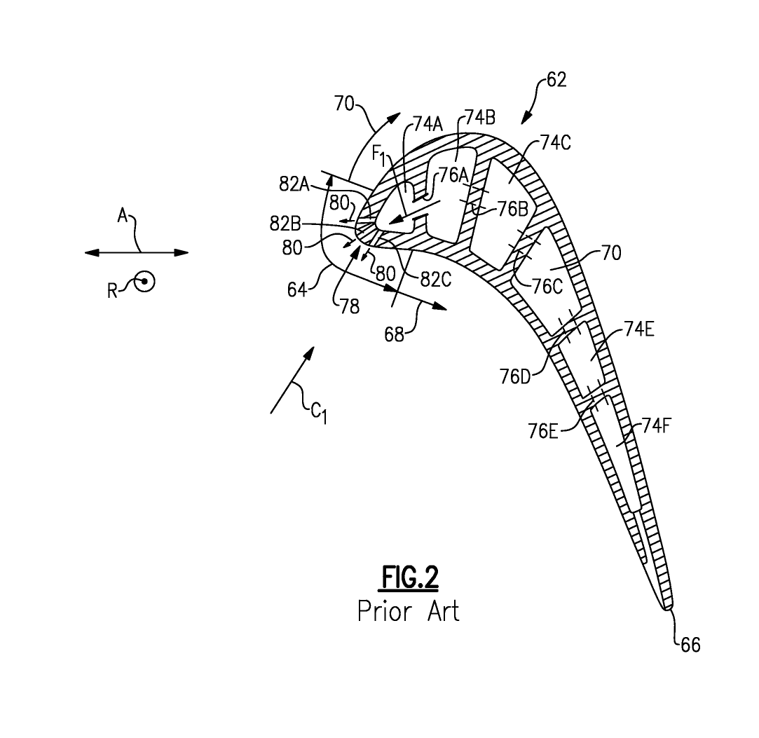

FIG. 2 illustrates a prior art engine component 62 in cross-section. In this example, the component 62 is a turbine blade. The component 62 includes a leading edge 64, a trailing edge 66, and opposed pressure and suction sides 68, 70, extending from the leading edge 64 to the trailing edge 66.

As is known in the art, the component 62 is attached to a rotor hub at a root thereof, and extends generally radially outward, in the radial direction R, which is normal to the engine central longitudinal axis A.

The component 62 includes a plurality of core passageways 74A-74F extending generally in the radial direction R. The core passageways 74A-74F are configured to communicate a flow of cooling fluid within the engine component 62. In one example, the core passageways 74A-74F are arranged to provide a serpentine passageway within the component 62, such as in prior U.S. Pat. No. 5,975,851 (assigned to United Technologies Corporation). In another example, the core passageways 74A-74F are in communication with one another by a number of axial passageways 76A-76E.

As is known in the art, a partial airflow C₁, which is a portion of the core airflow C, is configured to be expanded over the engine component 62. In this example, the partial airflow C₁ is directed toward the leading edge 64 (e.g., by an upstream set of vanes) toward a stagnation point 78. The stagnation point 78 is the point at which the partial airflow C₁ diverges, with a portion of the partial airflow C₁ being directed along the pressure side 68 of the component 62, and the other portion of the partial airflow C₁ being directed along the suction side 70 of the component 62.

In order to protect the component 62 from the relatively high temperatures associated with the partial airflow C₁, a showerhead film 80 is generated proximate the stagnation point 78. The showerhead film 80 is generated by directing a portion of a flow of cooling fluid F₁ from the core passageway 74A toward a plurality of showerhead holes 82A-82C formed in the leading edge 64 of the engine component 62.

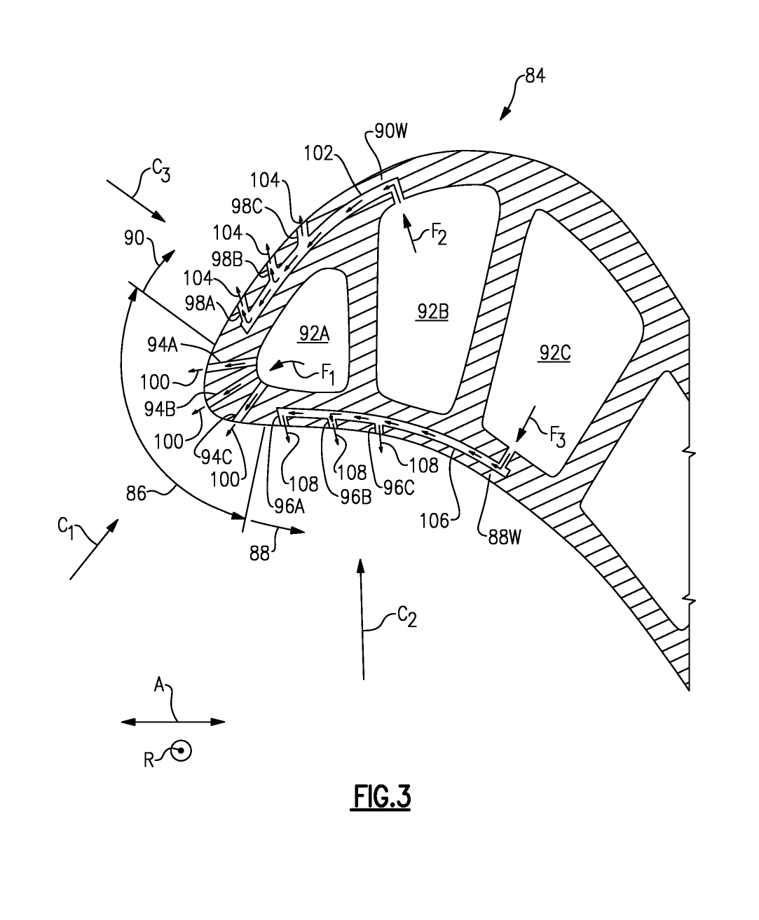

FIG. 3 illustrates a cooling configuration for an engine component 84 according to this disclosure. For exemplary purposes, the illustrated component 84 is a turbine blade. It should be understood that this disclosure could apply to other components, including but not limited to compressor blades, stator vanes, fan blades, and blade outer air seals (BOAS).

As is known in the art, the component 84 includes an airfoil section (the cross-section of the leading portion of which is illustrated in FIG. 3) provided radially between a root and a tip. The airfoil section includes a leading edge 86, a trailing edge (not shown), and opposed pressure and suction sides 88, 90 extending from the leading edge 86 to the trailing edge.

The component 84 further includes a plurality of radially extending core passageways 92A-92C. The core passageways 92A-92C are configured to route separate flows of cooling fluid within the component 84. In this example, the core passageways 92A-92C are provided with a common source of fluid (e.g., collocated) at a point proximate the root portion of the component 84. That common source of fluid is split into the core passageways 92A-92C. The core passageways 92A-92C are arranged such that the split flows of fluid do not intermix or otherwise communicate with one another when flowing within the airfoil section of the component 84 (unlike in the prior art example of FIG. 2).

The component 84 includes a plurality of groups of showerhead holes. While some systems only refer to cooling holes in the leading edge 86 as showerhead holes, the term showerhead holes will be used to refer to cooling holes in the pressure side 88 and the suction side 90 herein. These showerhead holes are typically high efficiency decreasing the external enthalpy of the external working fluid in a range of 100 to 500 Btu/lbm/s (e.g., approximately 230 to 1163 kJ/kg/s). For example, the component 84 includes a plurality of leading edge showerhead holes 94A-94C, a plurality of pressure side showerhead holes 96A-96C, and a plurality of suction side showerhead holes 98A-98C. Each group of showerhead holes 94A-94C, 96A-96C, and 98A-98C are in communication with a dedicated one of the core passageways 92A-92C, as will be explained below.

While only three showerhead holes are illustrated in each of the groups, it should be understood that there could be any number of leading edge, pressure side, and suction side showerhead holes. It should also be understood that while three groups of showerhead holes (e.g., 94A-94C, 96A-96C, and 98A-98C) are illustrated, additional groups of showerhead holes may be added. In that case, each additional group of showerhead holes would be provided with a source of cooling fluid from an additional, dedicated core passageway.

In this example, the leading edge showerhead holes 94A-94C are provided with a flow of fluid F₁ from the core passageway 92A. The fluid F₁ passes through the showerhead holes 94A-94C and creates a leading edge showerhead film 100.

Another, separate flow of fluid F₂ may be communicated from the core passageway 92B to the suction side showerhead holes 98C by way of a suction side passageway 102 formed in the suction side wall 90W of the component 84. In one example, the suction side passageway 102 is a microcircuit passageway. The suction side passageway 102 leads from the core passageway 92B to the suction side showerhead holes 98A-98C, and feeds the suction side showerhead holes 98A-98C in series in a flow direction normal to the radial direction of the blade. This creates a suction side showerhead film 104. Alternatively, the microcircuit could be fed directly from the foot feed of the blade negating the need for the dedicated passageway 92B before feeding the microcircuit.

Similarly, yet another flow of fluid F₃ may be communicated from the core passageway 92C to the pressure side showerhead holes 96A-96C via a pressure side passageway 106. In one example the pressure side passageway 106 is a microcircuit passageway. The pressure side passageway 106 is formed in the pressure side wall 88W of the component 84, and feeds the pressure side holes 96A-96C in series. The flow of fluid F₃ generates a pressure side showerhead film 108.

The component 84, as mentioned above, may be a turbine blade in one example. In this example, there may be an upstream set of vanes configured to rotate to vary the effective area of the engine 20, and to change the angle of incidence of the core airflow C. This rotation corresponds to different stages in the operational cycle of the engine 20. The incidence angle into relative to the component 84 may be altered through direct mechanical means (e.g., an upstream or downstream articulating body, such as a vane) or through a fluidic means by the alteration of incidence flow through operation of the engine. It should be understood that other configurations with static vanes come within the scope of this disclosure. (e.g., where, under the normal operation of the engine, the incidence angle to the blade changes).

As the upstream set of vanes rotates, or the operating point of the engine changes, the angle of incidence of the core airflow C, and thus the stagnation point, may change an amount significant enough to cause degradation of cooling design, as shown in FIG. 2. For instance, if the component 84 is arranged such that a partial airflow C₁ is introduced, the stagnation point will be provided at the leading edge 86 of the component 84. On the other hand, the partial airflow can be introduced from a positive angle of incidence, illustrated at C₂, which would provide a pressure side 88 stagnation point. Further, the partial airflow would be introduced from a negative angle of incidence, as illustrated at C₃, and the stagnation location would be provided on a suction side 90 of the component 84.

The arrangement disclosed in FIG. 3 is capable of accounting for changes in the angle of incidence of the core airflow C relative to the component 84 (e.g., such as between C₁-C₃) by providing showerhead holes at the leading edge 86, the pressure side 88, and the suction side 90. Further, by providing flows of fluid F₁-F₃ that are sourced from separated, dedicated core passageways 92A-92C, changes in the angle of incidence will not cause pressure imbalances that may lead to ingestion of a portion of the core airflow C into the engine component 84.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

What is claimed is:

1. A gas turbine engine, comprising:
a component having a leading edge, a pressure side and a suction side, the component including a first group of holes in the leading edge and a second group of holes in one of the pressure side and the suction side, the component including a first core passageway and a second core passageway separate from the first core passageway, the first core passageway and the second core passageway in communication with a respective one of the first group of holes and the second group of holes.

2. The gas turbine engine as recited in claim 1, wherein the first and second groups of holes are groups of showerhead holes.

3. The gas turbine engine as recited in claim 2, wherein the component includes a third group of showerhead holes in the other of the pressure side and the suction side, and wherein the component includes a third core passageway separate from the first and second core passageways, the third core passageway in communication with the third group of showerhead holes.

4. The gas turbine engine as recited in claim 3, wherein the component includes a pressure side wall and a suction side wall, and including a first passageway provided in one of the pressure side wall and the suction side wall configured to communicate fluid from the second core passageway to the second group of showerhead holes.

5. The gas turbine engine as recited in claim 4, wherein the first passageway feeds the second group of showerhead holes in series.

6. The gas turbine engine as recited in claim 3, the component includes a second passageway provided in the other of the pressure side wall and the suction side wall configured to communicate fluid from the third core passageway to the third group of showerhead holes.

7. The gas turbine engine as recited in claim 6, wherein the second passageway feeds the third group of showerhead holes in series.

8. The gas turbine engine as recited in claim 2, wherein the component includes an airfoil section, and wherein the first and second core passageways prevent a flow of fluid within the first core passageway from intermixing with a flow of fluid within the second core passageway when flowing within the airfoil section.

9. The gas turbine engine as recited in claim 2, wherein the component is a turbine blade.

10. A component for a gas turbine engine, comprising:
an airfoil section having a leading edge, a pressure side, and a suction side;
a first group of showerhead holes in the leading edge;
a second group of showerhead holes in one of the pressure side and the suction side; and
a first core passageway and a second core passageway configured to communicate fluid within the airfoil section, wherein the second core passageway is separate from the first core passageway, and wherein the first core passageway and the second core passageway in communication with a respective one of the first group of showerhead holes and the second group of showerhead holes.

11. The component as recited in claim 10, wherein the component includes a pressure side wall and a suction side wall, and including a first passageway provided in one of the pressure side wall and the suction side wall configured to communicate fluid from the second core passageway to the second group of showerhead holes.

12. The component as recited in claim 11, including a third group of showerhead holes in the other of the pressure side and the suction side, and wherein the component includes a third core passageway separate from the first core passageway and the second core passageway, the third group of showerhead holes in communication with the third core passageway.

13. The component as recited in claim 12, including a second passageway provided in the other of the pressure side wall and the suction side wall configured to communicate fluid from the third core passageway to the third group of showerhead holes.

14. The component as recited in claim 10, wherein the component is a turbine blade.

15. A method of operating a gas turbine engine, comprising:
cooling a first location on an exterior of an engine component with a first flow of fluid; and
cooling a second location on an exterior of the engine component with a second flow of fluid separate from the first flow of fluid.

16. The method as recited in claim 15, including:
creating a showerhead film adjacent a leading edge and at least one of a suction side and a pressure side of the component;
directing a portion of a core airflow toward the component.

17. The method as recited in claim 16, including changing an angle of incidence of the portion of the core airflow relative to the component.

18. The method as recited in claim 16, including creating a showerhead film adjacent both of the pressure side and the suction side of the component.

19. The method as recited in claim 16, including providing the first flow of fluid from a first core passageway of the component to create the showerhead film adjacent the leading edge, and providing the second flow of fluid from a second core passageway of the component to create a showerhead film adjacent one of the pressure side and the suction side.

20. The method as recited in claim 19, including providing a third flow of fluid from a third core passageway of the component to create a showerhead film adjacent the other of the pressure side and the suction side.
